(19) United States
(12) Patent Application Publication
(10) Pub. No.: US 2025/0206602 A1
(43) Pub. Date: Jun. 26, 2025

(54) SYSTEM AND METHOD FOR PRODUCING HYDROGEN

(71) Applicant: CATAGEN LIMITED, Belfast, Antrim (GB)

(72) Inventors: Andrew WOODS, Belfast, Antrim (GB); Robert DOUGLAS, Ballymena, Antrim (GB); Matthew ELLIOT, Newtownabbey, Antrim (GB)

(21) Appl. No.: 18/846,723

(22) PCT Filed: Mar. 14, 2023
(86) PCT No.: PCT/EP2023/056528

§ 371 Date: Sep. 13, 2024

(30) Foreign Application Priority Data
Mar. 14, 2022 (GB) 2203528.1

(51) Int. Cl. C01B 3/22; B01J 6/00; B01J 19/00; C01B 3/50

(52) U.S. Cl. CPC C01B 3/22; B01J 6/008; B01J 19/0013; B01J 19/0033; C01B 3/50; C01B 2203/0266; C01B 2203/0283; C01B 2203/04; C01B 2203/1217

(57) ABSTRACT

A system (100) for producing hydrogen. The system (100) comprises a pyrolysis reactor (102) arranged to receive a gas, introduce glycerine into the gas, and generate a pyrolysis product comprising hydrogen and carbon monoxide from the glycerine. The system (100) comprises a first heat transfer unit (118) comprising a first flow path through which the gas is arranged to flow prior to introduction to the pyrolysis reactor (102) and a second flow path through which the pyrolysis product is arranged to flow. The first heat transfer unit (118) is arranged to transfer heat from the pyrolysis product to the gas so as to raise the temperature of the gas. The system (100) may also comprise a water gas shift reactor that transforms carbon monoxide in the pyrolysis product into carbon dioxide and hydrogen. Unreacted glycerine in the pyrolysis product may be reintroduced to the pyrolysis reactor (102).

The present invention is directed towards a system and method for producing hydrogen, and in particular systems and methods for pyrolysis of glycerine (C₃H₈O₃) to syngas (CO+H₂). Glycerine is also known as glycerol and glycerin. Syngas may be used as a feedstock for production of green hydrogen and renewable hydrocarbon fuels.

### BACKGROUND

Existing methods for producing green hydrogen use either hydrolysis of water or a chemical process. These methods are relatively inefficient and require high energy consumption.

It is known that glycerine (C₃H₈O₃) can be transformed into carbon monoxide and hydrogen (syngas) using pyrolysis. Glycerine can be obtained as a by-product from biodiesel production.

United States Patent Application Publication No. US 2008/0131359 A1 discloses a method for producing a hydrogen product from a starting material containing glycerine. In this approach, glycerine undergoes pyrolysis and then a hydrogen separation to separate the hydrogen from residual gas. Prior to the hydrogen separation, a water gas shift reaction may be performed to transform carbon monoxide generated during the pyrolysis into hydrogen and carbon monoxide. The residual gas, which contains combustible components such as H2, CO and hydrocarbons is combusted and the released energy from the combustion is used to preheat the starting material.

It would be desirable to increase the efficiency of hydrogen gas production processes using pyrolysis either or both in terms of energy efficiency and conversion efficiency. It is particularly desired to increase the efficiency without requiring the combustion of residual gas.

### SUMMARY

According to the present invention, there is provided a system and method as set out in the accompanying claims. Other features of the invention will be apparent from the dependent claims, and the description which follows.

According to a first aspect of the disclosure, there is provided a system for producing hydrogen.

The system comprises a pyrolysis reactor arranged to receive a gas, introduce glycerine into the gas and generate a pyrolysis product comprising hydrogen and carbon monoxide from the glycerine.

The system further comprises a first heat transfer unit comprising a first flow path through which the gas is arranged to flow prior to introduction to the pyrolysis reactor and a second flow path through which the pyrolysis product is arranged to flow.

The first heat transfer unit is arranged to transfer heat from the pyrolysis product to the gas so as to raise the temperature of the gas.

Advantageously, in the first heat transfer unit, heat from the pyrolysis product is transferred to the gas. This raises the temperature of the gas prior to introduction to the pyrolysis reactor. As the temperature of the gas is raised, an amount of additional heating of the gas in the pyrolysis reactor is reduced. This increases the energy efficiency of the system, reduces cost and improves the feasibility of using glycerine as a renewable feedstock for hydrogen production.

The gas may comprise a carrier gas. The carrier gas may be an inert gas. The carrier gas may comprise nitrogen.

The gas may comprise glycerine. The glycerine may be obtained from the pyrolysis product. This means that unreacted glycerine is reintroduced to the pyrolysis reactor so as to improve the conversion efficiency of the process.

The pyrolysis reactor may comprise a furnace stage arranged to heat the gas.

The pyrolysis reactor may comprise a control stage arranged to introduce glycerine into the gas.

The pyrolysis reactor may comprise a reactor stage arranged to transform glycerine carried in the gas into hydrogen and carbon monoxide.

The gas may be introduced via a first inlet of the pyrolysis reactor. The glycerine may be introduced via a second inlet of the pyrolysis reactor.

The first flow path may be separated from the second flow path. The gas is therefore separated from and does not mix with the pyrolysis product.

The first heat transfer unit may comprise a heat exchanger.

The first heat transfer unit may be arranged to raise the temperature of the gas by at least 100 degrees centigrade. The first heat transfer unit may be arranged to lower the temperature of the pyrolysis product by at least 100 degrees centigrade.

The first heat transfer unit may be arranged to raise the temperature of the gas by at least 200 degrees centigrade. The first heat transfer unit may be arranged to lower the temperature of the pyrolysis product by at least 200 degrees centigrade.

The first heat transfer unit may be arranged to raise the temperature of the gas by at least 300 degrees centigrade. The first heat transfer unit may be arranged to lower the temperature of the pyrolysis product by at least 300 degrees centigrade.

The first heat transfer unit may be arranged to raise the temperature of the gas from a temperature of less than 100 degrees centigrade to a temperature of greater than or equal to 200 degrees centigrade.

The first heat transfer unit may be arranged to raise the temperature of the gas from a temperature of less than 100 degrees centigrade to a temperature of greater than or equal to 300 degrees centigrade.

The first heat transfer unit may be arranged to raise the temperature of the gas from a temperature of less than 100 degrees centigrade to a temperature of greater than or equal to 400 degrees centigrade.

The first heat transfer unit may be arranged to raise the temperature of the gas from a temperature of less than 100 degrees centigrade to a temperature of greater than or equal to 500 degrees centigrade.

The pyrolysis reactor may be arranged to further heat the gas to a temperature of greater than or equal to 500 degrees centigrade.

The pyrolysis reactor may be arranged to further heat the gas to a temperature of greater than or equal to 600 degrees centigrade.

The pyrolysis reactor may be arranged to further heat the gas to a temperature of greater than or equal to 700 degrees centigrade.

The first heat transfer unit may be arranged to lower the temperature of the pyrolysis product from a temperature of greater than or equal to 700 degrees centigrade to a temperature of less than or equal to 600 degrees centigrade.

The first heat transfer unit may be arranged to lower the temperature of the pyrolysis product from a temperature of greater than or equal to 700 degrees centigrade to a temperature of less than or equal to 500 degrees centigrade.

The first heat transfer unit may be arranged to lower the temperature of the pyrolysis product from a temperature of greater than or equal to 600 degrees centigrade to a temperature of less than or equal to 500 degrees centigrade.

The first heat transfer unit may be arranged to lower the temperature of the pyrolysis product from a temperature of greater than or equal to 700 degrees centigrade to a temperature of less than or equal to 400 degrees centigrade.

The first heat transfer unit may be arranged to lower the temperature of the pyrolysis product from a temperature of greater than or equal to 600 degrees centigrade to a temperature of less than or equal to 400 degrees centigrade.

The first heat transfer unit may be arranged to lower the temperature of the pyrolysis product from a temperature of greater than or equal to 500 degrees centigrade to a temperature of less than or equal to 400 degrees centigrade.

The first heat transfer unit may be arranged to lower the temperature of the pyrolysis product from a temperature of greater than or equal to 700 degrees centigrade to a temperature of less than or equal to 300 degrees centigrade.

The first heat transfer unit may be arranged to lower the temperature of the pyrolysis product from a temperature of greater than or equal to 600 degrees centigrade to a temperature of less than or equal to 300 degrees centigrade.

The first heat transfer unit may be arranged to lower the temperature of the pyrolysis product from a temperature of greater than or equal to 500 degrees centigrade to a temperature of less than or equal to 300 degrees centigrade.

The system may further comprise a separator arranged to receive the pyrolysis product from the first heat transfer unit and separate hydrogen from unreacted glycerine in the pyrolysis product.

The system may be arranged to reintroduce the unreacted glycerine to the pyrolysis reactor. The unreacted glycerine may be introduced via the first heat transfer unit. The unreacted glycerine may be carried with the gas to the pyrolysis reactor via the first heat transfer unit.

Advantageously, unused reactant is circulated back to the pyrolysis reactor. This improves the conversion efficiency of the system.

The system may comprise a water gas shift reactor arranged to receive the pyrolysis product from the first heat transfer unit and transform carbon monoxide in the pyrolysis product into carbon dioxide and hydrogen. The water gas shift reactor is arranged to transform carbon monoxide in the pyrolysis product with water in a water gas shift reaction to carbon dioxide and hydrogen.

Advantageously, the water gas shift reactor transforms the carbon monoxide in the pyrolysis product into carbon dioxide and hydrogen. This converts the carbon monoxide into useful materials.

Advantageously still, the water gas shift reaction achieves higher hydrogen formation at lower temperatures. This means that cooling the pyrolysis product via the first heat transfer unit does not negatively affect the water gas shift reaction process and can beneficially improve the reaction efficiency of the water gas shift reaction process.

The reaction temperature of the water gas shift reactor may be lower than the reaction temperature of the pyrolysis reactor. This means that the pyrolysis reaction occurs at a higher temperature than the water gas shift reaction.

The system may further comprise a second heat transfer unit comprising a first flow path through which the gas is arranged to flow prior to introduction to the pyrolysis reactor and a second flow path through which the pyrolysis product is arranged to flow from the water gas shift reactor. The second heat transfer unit is arranged to transfer heat from the pyrolysis product to the gas so as to raise the temperature of the gas.

Advantageously, in the second heat transfer unit, heat from the pyrolysis product is transferred to the gas. This raises the temperature of the gas prior to introduction to the pyrolysis reactor. As the temperature of the gas is raised, an amount of additional heating of the gas in the pyrolysis reactor is reduced. This increases the energy efficiency of the system.

The second heat transfer unit may comprise a heat exchanger.

The first and second heat transfer unit may be arranged such that the gas flows from the second heat transfer unit to the first heat transfer unit.

The first flow path may be separated from the second flow path. The gas is therefore separated from and does not mix with the pyrolysis product.

The second heat transfer unit may be arranged to raise the temperature of the gas by at least 100 degrees centigrade. The second heat transfer unit may be arranged to lower the temperature of the pyrolysis product by at least 100 degrees centigrade.

The second heat transfer unit may be arranged to raise the temperature of the gas by at least 200 degrees centigrade. The second heat transfer unit may be arranged to lower the temperature of the pyrolysis product by at least 200 degrees centigrade.

The second heat transfer unit may be arranged to raise the temperature of the gas from a temperature of less than 100 degrees centigrade to a temperature of greater than or equal to 200 degrees centigrade.

The second heat transfer unit may be arranged to raise the temperature of the gas from a temperature of less than 100 degrees centigrade to a temperature of greater than or equal to 300 degrees centigrade.

The second heat transfer unit may be arranged to lower the temperature of the pyrolysis product from a temperature of greater than or equal to 500 degrees centigrade to a temperature of less than or equal to 400 degrees centigrade.

The second heat transfer unit may be arranged to lower the temperature of the pyrolysis product from a temperature of greater than or equal to 500 degrees centigrade to a temperature of less than or equal to 300 degrees centigrade.

The system may further comprise a separator arranged to receive the pyrolysis product from water gas shift reactor and separate hydrogen from unreacted glycerine in the pyrolysis product. If the second heat transfer unit is provided, the pyrolysis product is received from the water gas shift reactor via the second heat transfer unit.

The system may be arranged to reintroduce the unreacted glycerine to the pyrolysis reactor. The system may be arranged to reintroduce the unreacted glycerine via the second heat transfer unit. The unreacted glycerine may be carried with the gas to the pyrolysis reactor via the second heat transfer unit.

The system may further comprise a system reservoir arranged to store the gas and a fluid delivery means arranged to deliver the gas to the pyrolysis reactor via the first heat transfer unit.

According to a second aspect of the disclosure, there is provided a method for producing hydrogen.

The method comprises flowing a gas through a first heat transfer unit into a pyrolysis reactor.

The method comprises introducing glycerine into the gas in the pyrolysis reactor.

The method comprises generating, in the pyrolysis reactor, a pyrolysis product comprising hydrogen and carbon monoxide from the glycerine.

The method comprises flowing the pyrolysis product through the first heat transfer unit.

In the first heat transfer unit, heat is transferred from the pyrolysis product to the gas so as to raise the temperature of the gas prior to introduction to the pyrolysis reactor.

According to a third aspect of the disclosure, there is provided a system for producing hydrogen.

The system comprises a pyrolysis reactor arranged to receive a gas, introduce glycerine into the gas, and generate a pyrolysis product comprising hydrogen and carbon monoxide from the glycerine.

The system comprises a separator arranged to receive the pyrolysis product and separate hydrogen from unreacted glycerine in the pyrolysis product.

The system is arranged to reintroduce the unreacted glycerine to the pyrolysis reactor.

Advantageously, unused reactant is circulated back to the pyrolysis reactor. This improves the conversion efficiency of the system.

The first heat transfer unit/second heat transfer unit are not required in the third aspect of the disclosure but may be provided. Any of the features of the first aspect of the disclosure may be included in the third aspect of the disclosure.

According to a fourth aspect of the disclosure, there is provided a method for producing hydrogen.

The method comprises flowing a gas into a pyrolysis reactor.

The method comprises introducing glycerine into the gas.

The method comprises generating, in the pyrolysis reactor, a pyrolysis product comprising hydrogen and carbon monoxide from the glycerine.

The method comprises flowing the pyrolysis product to a separator.

The method comprises separating hydrogen from unreacted glycerine in the pyrolysis product.

The method comprises reintroducing the unreacted glycerine to the pyrolysis reactor.

### BRIEF DESCRIPTION OF THE DRAWINGS

Examples of the present disclosure will now be described with reference to the accompanying drawings, in which:

FIGS. 1 and 2 show schematic diagrams of example hydrogen production systems according to aspects of the present disclosure;

FIG. 3 shows a schematic diagram for an example control system for controlling a hydrogen production system according to aspects of the present disclosure; and

FIGS. 4 and 5 show flow diagrams of example methods of producing hydrogen according to aspects of the present disclosure.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings but are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise.

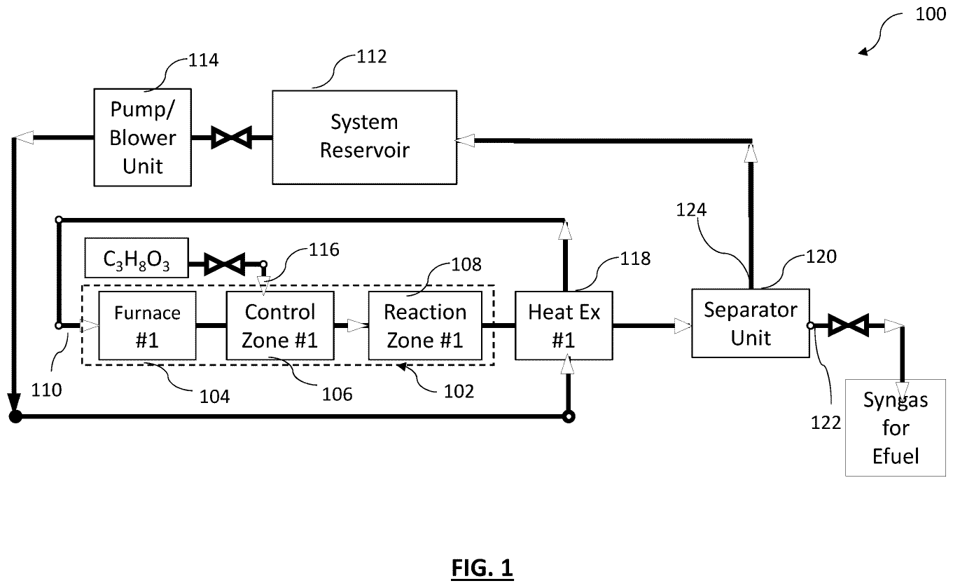

Referring to FIG. 1, there is shown an example system 100 for producing hydrogen according to aspects of the present disclosure.

The system comprises a pyrolysis reactor 102. The pyrolysis reactor 102 in this example comprises three stages. A furnace stage 104, a control stage 106, and a reactor stage 108. The furnace stage 104, control stage 106, and reactor stage 108 may also be referred to as a furnace zone, a control zone, and a reactor zone. The pyrolysis reactor 102 is not required to have this configuration and may take the form of any pyrolysis reactor suitable for transforming glycerine into hydrogen and carbon monoxide as known to the skilled person.

The furnace stage 104 comprises a receptable or one or more pressure flow tubes. The furnace stage 104 also comprises a thermal mass for heat storage and heat transfer. The furnace stage 104 comprises one or more heating elements. The one or more heating elements may be any form of heating element such as electrical, gas or liquid fuel combustion, or heat exchange. Pressure measurement and temperature measurement devices may also be provided. The furnace stage 104 may also comprise one or more flow control valves. The flow control valves may be operated with one or more remote actuators and/or mass flow controllers may be used. The furnace stage 104 may comprise one or more pressure relief valves.

The control stage 106 comprises a gas injector for controlling gas injection. The gas injector may comprise a mass flow controller. Pressure measurement, temperature measurement and flow measurement devices may also be provided. The control stage 106 may also comprise one or more flow control valves. The flow control valves may be operated with one or more remote actuators and/or mass flow controllers may be used.

The reactor stage 108 comprises a containment or pressure vessel or tube(s). Pressure measurement, temperature measurement and flow measurement devices may also be provided. The reactor stage 108 may also comprise one or more flow control valves. The flow control valves may be operated with one or more remote actuators and/or mass flow controllers may be used.

The pyrolysis reactor 102 has a first inlet 110 that receives a gas. The gas is received from a system reservoir 112 and delivered to the pyrolysis reactor 102 by fluid delivery means 114 which, in this example, is in the form of a pump/blower unit 114. The gas is delivered by the first inlet 112 to the furnace stage 104 of the pyrolysis reactor 102.

The system reservoir 112 comprises one or more pressure vessels for storing the gas. The system reservoir 112 may also comprise a heating element and/or a cooling element. Pressure measurement and temperature measurement devices may be provided. A flow controller for controlling the flow of the gas may also be provided. One or more valves such as isolation valves and pressure relief valves may also be provided.

The fluid delivery means 114 may be any form of blower/pump/compressor suitable for delivering gas. In some examples, a high speed centrifugal blower is used. The fluid delivery means may comprise a variable speed motor drive unit, one or more flow control devices, and one or more flow measurement devices.

In this example, the gas is a carrier gas that is suitable for carrying glycerine. Carrier gases are typically inert gasses. Any carrier gas suitable for carrying glycerine for glycerine pyrolysis may be used. For example, the carrier gas may be nitrogen. Alternatively, other examples of suitable carrier gases are argon, other halons or carbon dioxide.

The pyrolysis reactor 102 comprises a second inlet 116 that receives glycerine. The glycerine is introduced to the gas in the pyrolysis reactor 102. The glycerine is delivered by the second inlet 116. The control stage 106 comprises a gas injector which controls the injection of the glycerine into the gas.

The gas flowing to the furnace stage 104 via the first inlet 110 is heated by the furnace stage 104. Glycerine is introduced to the gas via the control stage 106. The control stage 106 controls the pyrolysis process to ensure that the desired gas composition, temperature and flow rate for pyrolysis are achieved. The glycerine carried by the gas is reacted in the reactor stage 108 in a pyrolysis reaction. The pyrolysis reaction transforms glycerine into hydrogen and carbon monoxide. The output flow from the reactor stage 108 is referred to as a pyrolysis product. The pyrolysis product comprises hydrogen and carbon monoxide. The pyrolysis product also comprises the carrier gas and any unreacted glycerine that was not transformed in the pyrolysis reaction.

The system 100 comprises a first heat transfer unit 118 that is arranged to receive the gas prior to introduction to the pyrolysis reactor 102 and receive the pyrolysis product from the pyrolysis reactor 102.

The first heat transfer unit 118 is in the form of a heat exchanger in this example. The heat exchanger may be any form of conventional gas-gas or gas-liquid heat exchanger. Temperature measurement and pressure measurement devices may also be provided.

The first heat transfer unit 118 defines a first flow path through which the gas flows and a second flow path through which the pyrolysis product flows. The first flow path is separated from the second flow path such that the gas does not mix with the pyrolysis product. The first flow path and second flow path are in close proximity to one another, and heat exchange occurs between the first flow path and the second flow path.

The first heat transfer unit 118 transfers heat from the pyrolysis product to the gas so as to raise the temperature of the gas. The first heat transfer unit 118 therefore acts to heat the gas and cool the pyrolysis product. This means that less energy is required in the pyrolysis reactor 102 to heat the gas to the required temperature for pyrolysis. As waste heat from the pyrolysis product is used to heat the gas the energy efficiency of the system is improved.

The pyrolysis product flowing from the first heat transfer unit 118 enters a separator 120, also referred to as a separator unit, that separates at least hydrogen from the remainder of the pyrolysis product. In this example, the separator 120 separates the hydrogen and carbon monoxide from the remainder of the pyrolysis product. Hydrogen and carbon monoxide are referred to as syngas.

The separator 120 may take the form of any separator suitable for separating at least hydrogen from a remainder of the pyrolysis product. The separator 120 may use a membrane separation process or pressure swing adsorption.

In this example, the separator 120 uses membrane separation and comprises a pressure vessel, a condensation apparatus, and a gas separation membrane. Pressure, temperature, and flow measurement devices may also be provided.

The syngas exits the separator 120 via first outlet 122. The syngas may be stored and may be used in a variety of applications such as e-fuels.

The remainder of the pyrolysis product comprises the carrier gas and any unreacted glycerine that was not transformed into hydrogen and carbon monoxide in the pyrolysis reactor 102. The remainder of the pyrolysis product exits the separator 120 via second outlet 124 and is returned to the system reservoir 112. Advantageously, this means that the unreacted glycerine is able to be reintroduced to the pyrolysis reactor 102 to generate hydrogen and carbon monoxide. This improves the conversion efficiency.

In an example implementation, the gas stored in the system reservoir 112 has a temperature of less than 100 degrees centigrade. The gas flowing through the first heat transfer unit 118 is heated to a temperature of about 400 degrees centigrade. This beneficially captures over 50/of the thermal energy in the pyrolysis product exiting the pyrolysis reactor 102. The gas is heated in the furnace stage 104 from a temperature of about 400 degrees centigrade to a temperature of about 700 degrees centigrade. This is a temperature suitable for the pyrolysis of glycerine to occur. The pyrolysis product flowing through the first heat transfer unit 118 is cooled from a temperature of about 700 degrees centigrade to a temperature of about 300 degrees centigrade.

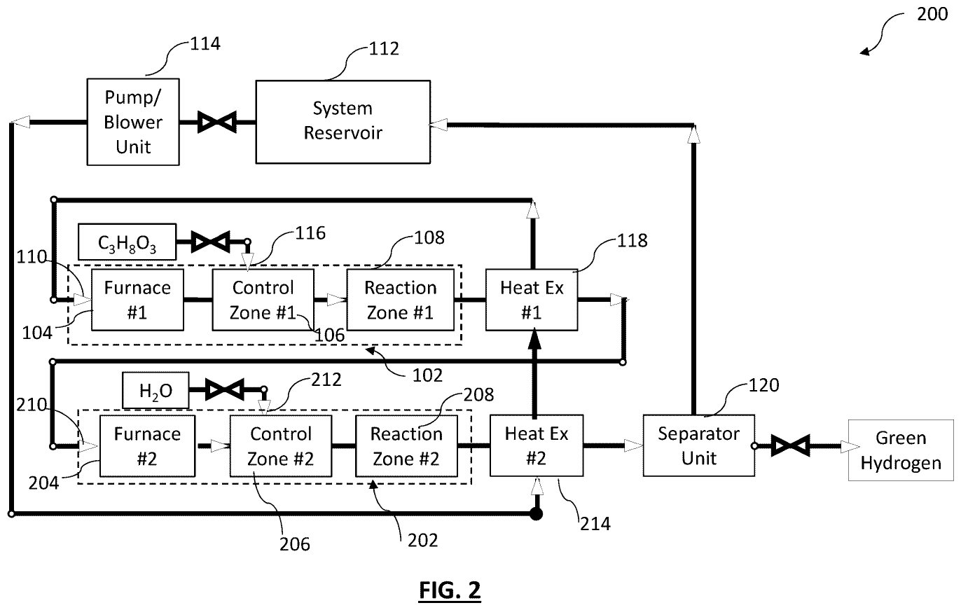

Referring to FIG. 2, there is shown another example system 200 for producing hydrogen according to aspects of the present disclosure.

The system 200 comprises the pyrolysis reactor 102, system reservoir 112, fluid transfer means 114, first heat transfer unit 118 and separator 120 as described above in relation to FIG. 1.

The system further comprises a water gas shift reactor 202 that is positioned between the first heat transfer unit 118 and the separator 120. The water gas shift reactor 202 in this example comprises three stages. A furnace stage 204, a control stage 206 and a reactor stage 208. The furnace stage 204, control stage 206, and reactor stage 208 may also be referred to as a furnace zone, a control zone, and a reactor zone. The water gas shift reactor 202 is not required to have this configuration and may take the form of any water gas shift reactor suitable for transforming carbon monoxide into carbon dioxide and hydrogen.

The water gas shift reactor has a first inlet 210 that receives the pyrolysis product from the first heat transfer unit 118. The pyrolysis product is delivered to the furnace stage 204 of the water gas shift reactor 202.

The water gas shift reactor has a second inlet 212 that receives water. The water is introduced as water vapour to the pyrolysis product. The water is delivered by the second inlet 212. The control stage 206 of the water gas shift reactor 206 comprises a gas injector which controls the injection of water vapour into the pyrolysis product.

The pyrolysis product flowing to the furnace stage 204 via the first inlet 210 is heated by the furnace stage 204. The furnace stage 204 may act to maintain the temperature of the pyrolysis product rather than increase the temperature of the pyrolysis product. Water vapour is introduced to the pyrolysis product in the control stage 206. The control stage 206 controls the water gas shift process to ensure that the desired gas composition, temperature and flow rate for the water gas shift reaction are achieved. The pyrolysis product with the introduced water vapour is introduced to the reactor stage 208 which transforms carbon monoxide in the pyrolysis product into carbon dioxide and hydrogen via a water gas shift reaction. Advantageously, the water gas shift reactor transforms the carbon monoxide in the pyrolysis product into carbon dioxide and hydrogen. This converts the carbon monoxide into useful materials and increases the amount of hydrogen generation by the system 200.

The water gas shift reaction is temperature dependent and the equilibrium constant decreases with an increase in temperature. Higher hydrogen formation is observed at lower temperatures. Advantageously, this means that cooling the pyrolysis product via the first heat transfer unit 118 does not negatively affect the water gas shift reaction process and can beneficially improve the reaction efficiency of the water gas shift reaction process.

The system 200 further comprises a second heat transfer unit 214 that is positioned between the water gas shift reactor 202 and the separator 120. The second heat transfer unit 214 is arranged to receive the gas prior to introduction to the pyrolysis reactor 102 and receive the pyrolysis product from the water gas shift reactor 202. The second heat transfer unit 214 is arranged such that the gas flows through the second heat transfer unit 214 prior to flowing through the first heat transfer unit 118. The second heat transfer unit 214 is in the form of a heat exchanger in this example. The heat exchanger may be any form of conventional gas-gas or gas-liquid heat exchanger. Temperature measurement and pressure measurement devices may also be provided.

The second heat transfer unit 214 defines a first flow path through which the gas flows and a second flow path through which the pyrolysis product flows. The first flow path is separated from the second flow path such that the gas does not mix with the pyrolysis product. The first flow path and second flow path are in close proximity to one another, and heat exchange occurs between the first flow path and the second flow path.

The second heat transfer unit 214 transfers heat from the pyrolysis product to the gas so as to raise the temperature of the gas. The second heat transfer unit 214 therefore acts to heat the gas and cool the pyrolysis product. This means that less energy is required in the pyrolysis reactor 102 to heat the gas to the required temperature for pyrolysis. As waste heat from the pyrolysis is used to heat the gas the energy efficiency of the system is improved. Advantageously, in this arrangement, heat is regenerated from both the pyrolysis reaction and the water gas shift reaction.

The pyrolysis product flowing from the second heat transfer unit 214 enters the separator 120 that separates at least hydrogen from the remainder of the pyrolysis product. The separator 120 may separate the hydrogen and the carbon dioxide from the remainder of the pyrolysis product.

The hydrogen and optionally the carbon dioxide may exit the separator 120 via first outlet 122. The hydrogen may be stored and may be used in a variety of applications such as e-fuels.

The remainder of the pyrolysis product comprises the carrier gas and any unreacted glycerine that was not transformed into hydrogen and carbon monoxide in the pyrolysis reactor 102. The remainder of the pyrolysis product exits the separator 120 via second outlet 124 and is returned to the system reservoir 112. Advantageously, this means that the unreacted glycerine is able to be reintroduced to the pyrolysis reactor 102 to generate hydrogen and carbon monoxide. This improves the conversion efficiency.

In an example implementation, the gas stored in the system reservoir 112 has a temperature of less than 100 degrees centigrade. The combination of the second heat transfer unit 214 and the first heat transfer unit 118 heats the gas to a temperature of about 500 degrees centigrade. This beneficially captures over 50% of the thermal energy in the pyrolysis product exiting the pyrolysis reactor 102 and the water gas shift reactor 202. The gas is heated in the furnace stage 104 from a temperature of about 500 degrees centigrade to a temperature of about 700 degrees centigrade. This is a temperature suitable for the pyrolysis of glycerine to occur. The pyrolysis product flowing through the first heat transfer unit 118 is cooled from a temperature of about 700 degrees centigrade to a temperature of about 500 degrees centigrade. The furnace 204 maintains the temperature of the pyrolysis product at about 500 degrees centigrade. The pyrolysis product flowing through the second heat transfer unit 214 is cooled from a temperature of about 500 degrees centigrade to a temperature of about 300 degrees centigrade.

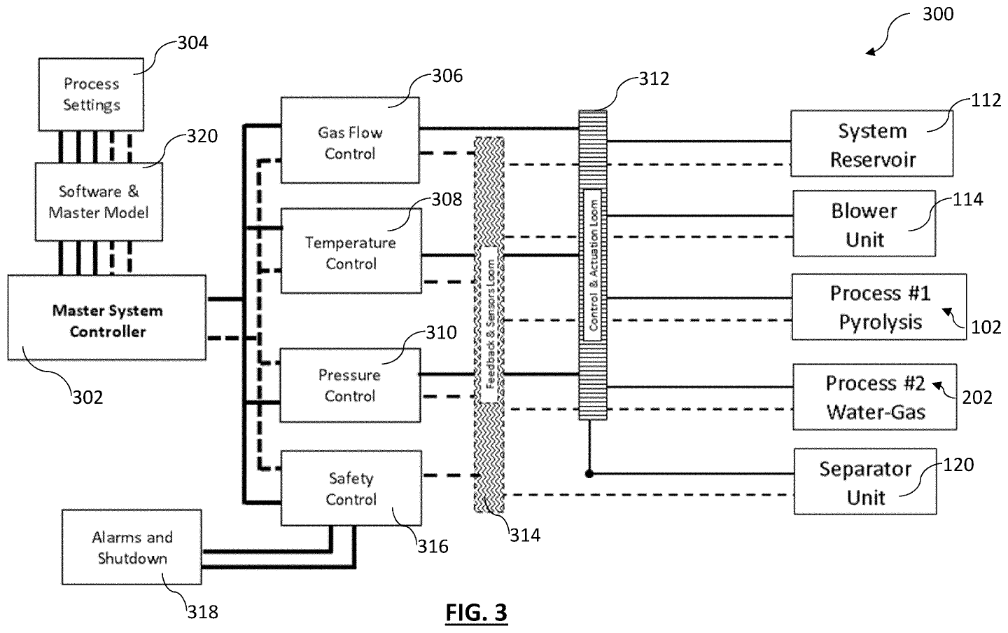

FIG. 3 shows a control system 300 used to control and/or monitor the operation of the hydrogen production system 100, 200 according to aspects of the present disclosure. In the Figure, solid lines indicate control signals and dashed lines indicate feedback and/or sensor signals.

The control system 300 typically comprises a master system controller 302 which is typically implemented by one or more suitable programmed or configured hardware, firmware and/or software controllers, e.g., comprising one or more suitable programmed or configured microprocessor, microcontroller or other processor, for example an IC processor such as an ASIC, DSP or FPGA (not illustrated).

In preferred examples, the control system 300 communicates control information to other components of the system such as the system reservoir 112, fluid delivery means 114, pyrolysis reactor 102, water-gas shift reactor 202, and separator 120. Process settings may be received via a process setting interface unit 304. The process settings may specify environmental conditions, for example in relation to temperature(s), flow rate(s), and/or pressure(s).

In the example shown in FIG. 3, a gas flow control module 306 generates control signals for controlling the gas flow rate, a temperate control module 308 generates control signals for controlling the temperature, a pressure control module 310 generates control signals for controlling the pressure. The control signals are supplied to a control and actuation loom 312 which routes the control signals to the desired components of the system.

The control system 300 may also receive feedback information from other components such as sensors (e.g., incorporated into the pyrolysis reactor and/or water gas shift reactor) in response to which the control system 300 may issue control information to one or more relevant components. The feedback information is received via a feedback and sensor loom 314 in this example.

The control system 300 may perform analysis of the measurements or other information provided. This analysis may be carried out automatically in real time by the control system 300. Alternatively, or in addition, analysis of the system measurements and performance may be made by an operator in real time or offline. The operator may make adjustments to the operation of the system by providing control instructions via the process settings interface 304.

A safety control module 316 may be provided, which may receive alarm signals from one or more alarm sensors (not shown), e.g., gas sensors, temperature sensors, leak detectors or emergency stops that may be included in the system. The safety control module 316 provides alarm information to the master controller 302 based on the alarm signals received from the alarm sensors. The safety control module 316 may also control an alarm and shutdown module 318 to generate an alarm for the operator and/or shutdown the operation of the system.

In preferred examples, the control system 300, and more particularly the master controller 302 is configured to implement system modelling logic, e.g., by supporting mathematical modelling software or firmware 320, for enabling the control system 300 to mathematically model the behaviour of the system, depending on the process settings and/or on feedback signals received from one or more system components during operation of the system.

Optionally, the control system 300 is configured to implement Model Predictive Control (MPC). Using MPC, the control system 300 causes the control action of the control modules 306, 308, 310, 316 to be adjusted before a corresponding deviation from a relevant process set point actually occurs. This predictive ability, when combined with traditional feedback operation, enables the control system 300 to make adjustments that are smoother and closer to the optimal control action values that would otherwise be obtained. A control model can be written in Matlab, Simulink, or Labview by way of example and executed by the master controller 302. Advantageously, MPC can handle MIMO (Multiple Inputs, Multiple Outputs) systems.

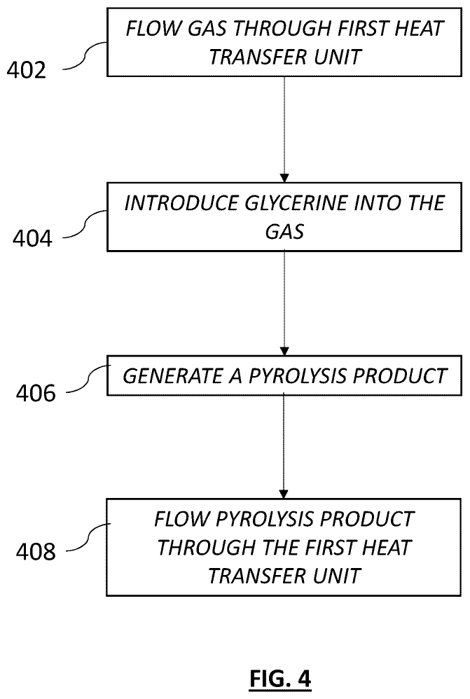

FIG. 4 shows a flow diagram for an example method of producing hydrogen. The method may be performed by the system 100, 200 as described above.

Step 402 comprises flowing a gas through a first heat transfer unit and into a pyrolysis reactor.

Step 404 comprises introducing glycerine into the gas in the pyrolysis reactor.

Step 406 comprises generating, in the pyrolysis reactor, a pyrolysis product comprising hydrogen and carbon monoxide from the glycerine.

Step 408 comprises flowing the pyrolysis product through the first heat transfer unit.

In the first heat transfer unit, heat is transferred from the pyrolysis product to the gas so as to raise the temperature of the gas prior to introduction to the pyrolysis reactor.

In the above examples, the first heat transfer unit 118 and optionally the second heat transfer unit 214 are provided to regenerate heat from the pyrolysis reaction/water gas shift reaction.

The heat transfer units are not required in all examples. Advantageous effects are also achieved by recirculating unreacted glycerine from the separator 120 back to the pyrolysis reactor 102. This improves the conversion efficiency of the system and avoids wasting glycerine. In this examples, the first heat transfer unit 118 and optionally the second heat transfer unit 214 may be provided but they are not required.

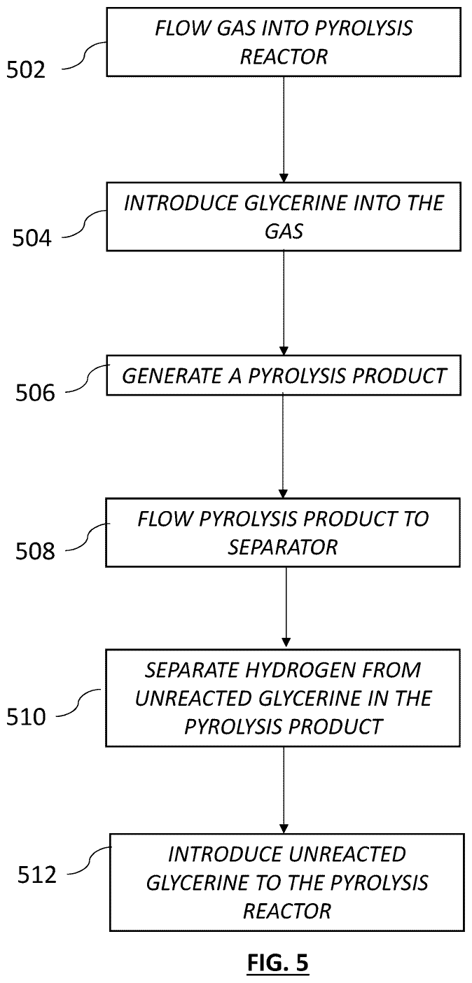

FIG. 5 shows a flow diagram for an example method of producing hydrogen. The method may be performed by the system 100, 200 as described above.

Step 502 comprises flowing a gas into a pyrolysis reactor.

Step 504 comprises introducing glycerine into the gas.

Step 506 comprises generating, in the pyrolysis reactor, a pyrolysis product comprising hydrogen and carbon monoxide from the glycerine;

Step 508 comprises flowing the pyrolysis product to a separator;

Step 510 comprises separating hydrogen from unreacted glycerine in the pyrolysis product; and

Step 512 comprises reintroducing the unreacted glycerine to the pyrolysis reactor

Various combinations of optional features have been described herein, and it will be appreciated that described features may be combined in any suitable combination. In particular, the features of any one example embodiment may be combined with features of any other embodiment, as appropriate, except where such combinations are mutually exclusive. Throughout this specification, the term “comprising” or “comprises” means including the component(s) specified but not to the exclusion of the presence of others.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1-25. (canceled)

26. A system for producing hydrogen, the system comprising:
a pyrolysis reactor arranged to receive a gas, introduce glycerine into the gas, and generate a pyrolysis product comprising hydrogen and carbon monoxide from the glycerine; and
a first heat transfer unit comprising a first flow path through which the gas is arranged to flow prior to introduction to the pyrolysis reactor, and a second flow path through which the pyrolysis product is arranged to flow, and wherein the first heat transfer unit is arranged to transfer heat from the pyrolysis product to the gas so as to raise the temperature of the gas; wherein said system further comprises a separator arranged to receive the pyrolysis product from the first heat transfer unit and separate hydrogen from unreacted glycerine in the pyrolysis product;
and wherein the system is arranged to reintroduce the unreacted glycerine to the pyrolysis reactor.

27. A system as claimed in claim 26, wherein the gas comprises glycerine.

28. A system as claimed in claim 27, wherein the glycerine in the gas is obtained from the pyrolysis product.

29. A system as claimed in claim 26, wherein the first heat transfer unit is arranged to raise the temperature of the gas by at least 100 degrees centigrade.

30. A system as claimed in claim 29, wherein the first heat transfer unit is arranged to raise the temperature of the gas by at least 200 degrees centigrade.

31. A system as claimed in claim 30, wherein the first heat transfer unit is arranged to raise the temperature of the gas by at least 300 degrees centigrade.

32. A system as claimed in claim 26, wherein the first heat transfer unit is arranged to lower the temperature of the pyrolysis product by at least 100 degrees centigrade.

33. A system as claimed in claim 32, wherein the first heat transfer unit is arranged to lower the temperature of the pyrolysis product by at least 200 degrees centigrade.

34. A system as claimed in claim 33, wherein the first heat transfer unit is arranged to lower the temperature of the pyrolysis product by at least 300 degrees centigrade.

35. A system as claimed in claim 26, wherein the unreacted glycerine is carried with the gas to the pyrolysis reactor via the first heat transfer unit.

36. A system for producing hydrogen, the system comprising:
a pyrolysis reactor arranged to receive a gas, introduce glycerine into the gas, and generate a pyrolysis product comprising hydrogen and carbon monoxide from the glycerine;
a first heat transfer unit comprising a first flow path through which the gas is arranged to flow prior to introduction to the pyrolysis reactor, and a second flow path through which the pyrolysis product is arranged to flow, and wherein the first heat transfer unit is arranged to transfer heat from the pyrolysis product to the gas so as to raise the temperature of the gas;
a water gas shift reactor arranged to receive the pyrolysis product from the first heat transfer unit and transform carbon monoxide in the pyrolysis product into carbon dioxide and hydrogen;
said system further comprising a second heat transfer unit comprising a first flow path through which the gas is arranged to flow prior to introduction to the pyrolysis reactor and a second flow path through which the pyrolysis product is arranged to flow from the water gas shift reactor, and wherein the second heat transfer unit is arranged to transfer heat from the pyrolysis product to the gas so as to raise the temperature of the gas;
said system further comprising a separator arranged to receive the pyrolysis product from the water gas shift reactor and separate hydrogen from unreacted glycerine in the pyrolysis product, and wherein the system is arranged to reintroduce the unreacted glycerine to the pyrolysis reactor.

37. A system as claimed in claim 36, wherein the reaction temperature of the water gas shift reactor is lower than the reaction temperature of the pyrolysis reactor.

38. A system as claimed in claim 36, wherein the first heat transfer unit and the second heat transfer unit are arranged such that gas flows from the second heat transfer unit to the first heat transfer unit.

39. A system as claimed in claim 36, wherein the second heat transfer unit is arranged to raise the temperature of the gas by at least 100 degrees centigrade.

40. A system as claimed in claim 33, wherein the unreacted glycerine is carried with the gas to the pyrolysis reactor via the second heat transfer unit.

41. A system as claimed in claim 26, further comprising a system reservoir arranged to store the gas and a fluid delivery means arranged to deliver the gas to the pyrolysis reactor via the first heat transfer unit.

42. A system as claimed in claim 26, wherein the pyrolysis reactor comprises a furnace zone, a control zone and a reactor zone.

43. A system as claimed in claim 26, wherein the pyrolysis reactor has a first inlet that receives the gas and a second inlet that receives the glycerine.

44. A system as claimed in claim 43, wherein the gas is delivered by the first inlet to the furnace zone of the pyrolysis reactor.

45. A system as claimed in claim 43, wherein the glycerine is delivered by the second inlet.

46. A method for producing hydrogen, the method comprising:
flowing a gas through a first heat transfer unit and into a pyrolysis reactor, wherein said gas comprises a carrier gas suitable for carrying glycerine;
introducing glycerine into the gas in the pyrolysis reactor;
generating, in the pyrolysis reactor, a pyrolysis product comprising hydrogen and carbon monoxide from the glycerine;
flowing the pyrolysis product through the first heat transfer unit,
wherein in the first heat transfer unit, heat is transferred from the pyrolysis product to the gas so as to raise the temperature of the gas prior to introduction to the pyrolysis reactor;
flowing the pyrolysis product to a separator, said separator being arranged to receive the pyrolysis product from the first heat transfer unit;
separating hydrogen from unreacted glycerine in the pyrolysis product; and
reintroducing the unreacted glycerine to the pyrolysis product.
